(19) United States
(12) Patent Application Publication
(10) Pub. No.: US 2004/0190312 A1
(43) Pub. Date: Sep. 30, 2004

(54) Switching power supply

(75) Inventor: Koji Takada, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 10/805,432

(22) Filed: Mar. 22, 2004

(30) Foreign Application Priority Data
Mar. 24, 2003 (JP) 2003-079770

(51) Int. Cl. H02M 3/335

(52) U.S. Cl. 363/21.12

(57) ABSTRACT

A switching power supply that improves utilization efficiency of individual transformers and is suitable for miniaturization is provided. Also a switching power supply suitable for reduction in thickness is provided. A switching power supply including a rectifying circuit for rectifying an AC voltage, a smoothing capacitor for smoothing an output of the rectifying circuit, and plural transformers to which a voltage of the smoothing capacitor is applied by turning on/off of a switching circuit and which induce a voltage to be an output at secondary windings, wherein the transformers have first primary windings connected in parallel and second primary windings connected in series, the first primary windings, the second primary windings, the switching circuit and the smoothing capacitor are connected in series, and a connection point between the first primary windings and the second primary windings is connected to the AC voltage via a diode and a first magnetic element.

### BACKGROUND OF THE INVENTION

1. Field of the invention

This invention relates to a switching power supply having plural transformers, particularly mounted in a thin shape.

2. Description of the Prior Art

A conventional switching power supply has one transformer (see, for example, Patent Literature 1). In such a conventional example, the large size of the transformer makes it difficult to reduce the thickness of the switching power supply.

To solve this problem, a switching power supply in which plural transformers share a load has been proposed (see, for example, Patent Literature 1 and Patent Literature 3).

Patent Literature 1: Specification of U.S. Pat. No. 5,673,184

Patent Literature 2: Specification of U.S. Pat. No. 6,282,103

Patent Literature 3: Specification of U.S. Pat. No. 6,469,486

Such a switching power supply having plural transformers will now be described with reference to FIG. 1. FIG. 1 is a structural view showing a conventional switching power supply.

In FIG. 1, a common potential COM and a common potential GND are used common potentials of the switching power supply. An AC voltage Vac is connected to a rectifying circuit DB1 via a filter circuit 40. The rectifying circuit DB1 rectifies the AC voltage Vac.

The rectifying circuit DB1 is connected to a smoothing capacitor Cin via an inductor L2 as a first magnetic element, a diode D2 and transformers T41, T42, T43. The rectifying circuit DB1 is also connected to a capacitor Cf. The smoothing capacitor Cin smoothes an output of the rectifying circuit DB1.

The transformer T41 has a first primary winding T41n1, a second primary winding T41n2 and a secondary winding T41n3. The transformer T42 has a first primary winding T42n1, a second primary winding T42n2 and a secondary winding T42n3. The transformer T43 has a first primary winding T43n1, a second primary winding T43n2 and a secondary winding T43n3.

The number of turns in each of the first primary windings T41n1, T42n1 and T43n1 is set to be the number of turns n1, and the number of turns in each of the second primary windings T41n2, T42n2 and T43n2 is set to be the number of turns n2. The transformers T41, T42, T43 thus have substantially the same properties.

The first primary winding T41n1 of the transformer T41, the first primary winding T42n1 of the transformer T42 and the first primary winding T43n1 of the transformer T43 are connected in parallel.

The second primary winding T41n2 of the transformer T41, the second primary winding T42n2 of the transformer T42 and the second primary winding T43n2 of the transformer T43 are connected in series.

The first primary windings T41n1, T42n1, T43n1, a switching element Q1 and the smoothing capacitor Cin are connected in series.

The second primary windings T41n2, T42n2, T43n2 are connected between the diode D2 and the smoothing capacitor Cin.

Therefore, as the switching element Q1 is turned on/off, a voltage of the smoothing capacitor Cin is applied to the transformers T41, T42, T43. Then, a voltage to be an output is induced at the secondary windings T41n3, T42n3, T43n3 of the transformers T41, T42, T43.

The secondary winding T41n3 of the transformer T41 is connected to a diode Drec1. The secondary winding T42n3 of the transformer T42 is connected to a diode Drec2. The secondary winding T43n3 of the transformer T43 is connected to a diode Drec3. The diodes Drec1, Drec2, Drec3 are connected in parallel and are further connected to a capacitor Cout and a load Load.

The voltages induced at the secondary windings T41n3, T42n3, T43n3 are rectified by the diodes Drec1, Drec2, Drec3, then smoothed by the capacitor Cout, and become an output voltage Vout to supply power to the load Load.

The output voltage Vout is fed back to a driving signal Vg of the switching element Q1 via a control circuit 20. The control circuit 20 performs control so that the output voltage Vout has a predetermined value. In this manner, the AC voltage Vac is converted to the output voltage Vout. The transformers T41, T42, T43 share the load substantially equally.

The turning on/off of the switching element Q1 generates a high-frequency AC voltage source at a connection point P between the second primary windings T41n2, T42n2, T43n3 and the diode D2.

Therefore, in the conventional example of FIG. 1, the AC voltage Vac and the connection point P, which is the high-frequency AC voltage source, are connected with each other via the filter circuit 40, the rectifying circuit DB1, the inductor L1 as the first magnetic element, and the diode D2.

Moreover, a blocking diode D1 is connected between the rectifying circuit DB1 and the smoothing capacitor Cin.

In the conventional example of FIG. 1 as described above, continuity of an input current Iin is facilitated and the power factor increases.

However, in the conventional example of FIG. 1, since a high voltage Vcin of the smoothing capacitor Cin is applied to the first primary windings T41n1, T42n1, T43n1, the number of turns in each of the first primary windings T41n1, T42n1, T43n1 must be designed to be large. Also the second primary windings T41n2, T42n2, T43n2 are necessary.

Particularly in the case of using a three-layer insulating wire with coating of high withstand voltage for the first primary windings T41n1, T42n1, T43n1 and the second primary windings T41n2, T42n2, T43n2, the rate of occupation of copper wires in the bobbins of the transformers T41, T42, T43 is lowered because of the thick coating, and the utilization efficiency is lowered.

Moreover, if the transformers T41, T42, T43 are small in size and height, their bobbins have narrow spools and the utilization efficiency is lowered further.

The three-layer insulating wire does not need a barrier tape required by the safety standards and therefore it is preferred for improving the utilization efficiency of the spool. Therefore, a small transformer generally uses a three-layer insulating wire.

The first primary windings and the second primary windings with coating of high withstand voltage conformable to the safety standards do not need a barrier tape required by the safety standards and therefore these windings are suitable for the transformers T41, T42, T43, which are small in size and height.

Such lowering of the utilization efficiency of the transformers T41, T42, T43 is a problem that it obstructs miniaturization of the switching power supply.

### SUMMARY OF THE INVENTION

It is an object of this invention to provide a switching power supply that solves the above-described problem, enables improvement in the utilization efficiency of each transformer, and is suitable for miniaturization. Particularly, it is an object of this invention to provide a switching power supply suitable for reduction in thickness.

### BRIEF DESCRIPTION OF THE DRAWINGS

FIG. 1 is a structural view showing a conventional switching power supply.

FIG. 2 is a structural view showing an embodiment of this invention.

FIG. 3 shows an operating waveform of each part in the embodiment of FIG. 2.

FIG. 4 shows an operating waveform of each part in the embodiment of FIG. 2.

FIG. 5 shows an operating waveform of each part in the embodiment of FIG. 2.

FIGS. 6A to 6D are schematic diagrams showing operations during individual periods in the embodiment of FIG. 2.

FIG. 7 is a structural view showing a second embodiment of this invention.

FIG. 8 is a structural view showing a third embodiment of this invention.

FIG. 9 is a structural view showing a fourth embodiment of this invention.

FIG. 10 is a structural view showing a fifth embodiment of this invention.

FIGS. 11A to 11H are structural views showing examples of an output circuit.

FIG. 12 is a structural view showing a sixth embodiment of this invention.

FIG. 13 is a structural view showing a seventh embodiment of this invention.

FIG. 14 is a structural view showing an eighth embodiment of this invention.

FIG. 15 shows an operating waveform of each part in an unbalanced state in the embodiment of FIG. 13.

FIG. 16 shows an operating waveform of each part in an unbalanced state in the embodiment of FIG. 2.

FIG. 17 is a structural view showing a ninth embodiment of this invention.

FIG. 18 is a structural view showing a tenth embodiment of this invention.

### DETAILED DESCRIPTION OF THE PREFERRED EMBODIMENTS

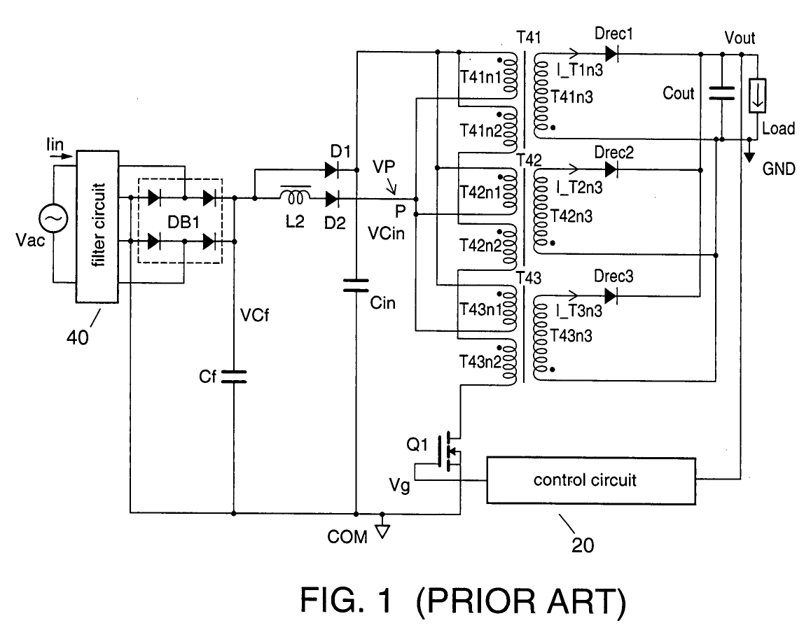

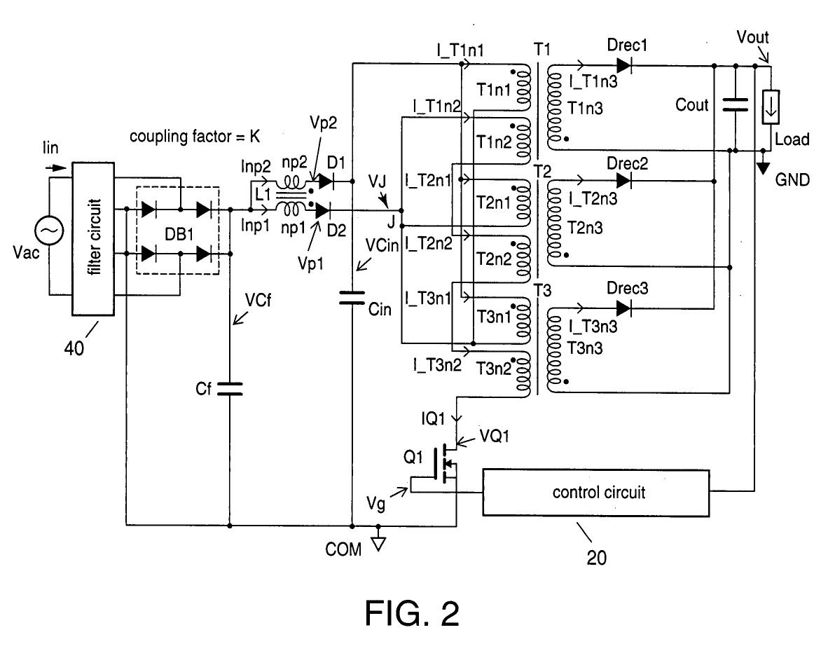

Hereinafter, this invention will be described in detail with reference to FIG. 2. FIG. 2 is a structural view showing an embodiment of a switching power supply according to this invention. The same elements as those in the conventional example of FIG. 1 are denoted by the same symbols and numerals and will not be described further in detail.

A first characteristic feature of the embodiment of FIG. 2 is that first primary windings T1n1, T2n1, T3n1, which are connected in parallel, are connected in series with second primary windings T1n2, T2n2, T3n2, which are connected in series.

A second characteristic feature of the embodiment of FIG. 2 is that a connection point J between the first primary windings T1n1, T2n1, T3n1 and the second primary windings T1n2, T2n2, T3n2 is connected to an AC voltage Vac via a diode D2, a coupled inductor L1 as a first magnetic element, a rectifying circuit DB1 and a filter circuit 40.

Specifically, a transformer T1 has the first primary winding T1n1, the second primary winding T1n2 and a secondary winding T1n3. A transformer T2 has the first primary winding T2n1, the second primary winding T2n2 and a secondary winding T2n3. A transformer T3 has the first primary winding T3n1, the second primary winding T3n2 and a secondary winding T3n3.

The first primary winding T1n1 of the transformer T1, the first primary winding T2n1 of the transformer T2 and the first primary winding T3n1 of the transformer T3 are connected in parallel.

The second primary winding T1n2 of the transformer T1, the second primary winding T2n2 of the transformer T2 and the second primary winding T3n2 of the transformer T3 are connected in series.

The number of turns in each of the first primary windings T1n1, T2n1, T3n1 is set to be the number of turns n1, and the number of turns in each of the second primary windings T1n2, T2n2, T3n2 is set to be the number of turns n2. The transformers T1, T2, T3 thus have substantially the same properties.

The first primary windings T1n1, T2n1, T3n1 and the second primary windings T1n2, T2n2, T3n2 are connected in series. A switching element Q1 and a smoothing capacitor Cin are connected in series with these windings.

Moreover, the first primary windings T1n1, T2n1, T3n1 are connected to the smoothing capacitor Cin. The second primary windings T1n2, T2n2, T3n2 are connected to the switching element Q1.

Therefore, when the switching element Q1 is on, the ratio of a voltage applied to the first primary windings T1n1, T2n1, T3n1 to a voltage applied to the second primary windings T1n2, T2n2, T3n2 is (n1/3):n2.

The connection point J between the first primary windings T1n1, T2n1, T3n1 and the second primary windings T1n2, T2n2, T3n2 is connected to the AC voltage Vac via the diode D2, the coupled inductor L1 as the first magnetic element, the rectifying circuit DB1 and the filter circuit.

In the embodiment of FIG. 2, the connection point J between the first primary windings T1n1, T2n1, T3n1 and the second primary windings T1n2, T2n2, T3n2 is connected to the rectifying circuit DB1. However, the connection point J between the first primary windings T1n1, T2n1, T3n1 and the second primary windings T1n2, T2n2, T3n2 may be connected to the AC voltage Vac via a diode other than the rectifying circuit DB1. The structure and operation in this case will be later described in detail in an embodiment shown in FIG. 13.

As in the conventional example of FIG. 1, as the switching element Q1 is turned on/off, a high-frequency AC voltage source is generated at the connection point J between the first primary windings T1n1, T2n1, T3n1 and the second primary windings T1n2, T2n2, T3n2.

In the embodiment of FIG. 2, the AC voltage Vac and the connection point J, which is the high-frequency AC voltage source, are connected via the filter circuit 40, the rectifying circuit DB1, the coupled inductor L1 as the first magnetic element and the diode D2.

The coupled inductor L1 has a winding np1 and a winding np2. The winding np1 and the winding np2 are magnetically coupled. One end of the winding np1 is connected to the diode D2. One end of the winding np2 is connected to a blocking diode D1. The other end of the winding np1 and the other end of the winding np2 are connected to the rectifying circuit DB1.

That is, the rectifying circuit DB1 is connected to the smoothing capacitor Cin via the coupled inductor L1 as a second magnetic element and the block diode D1.

As the winding np1 is the first magnetic element and the winding np2 is the second magnetic element, the first magnetic element and the second magnetic element are magnetically coupled. The coupled inductor L1 serves as the first magnetic element and as the second magnetic element.

In the embodiment of FIG. 2, when a coupling factor K between the winding np1 and the winding np2 of the coupled inductor L1 is small, that is, when the windings np1 and np2 are loosely coupled, power can be converted at a more preferable power factor. This is described in detail in Patent Literature 2 (U.S. Pat. No. 6,282,103) and therefore will not be described here.

The blocking diode D1 acts to facilitate charging of the smoothing capacitor Cin and stabilize its operation when the switching power supply is turned on.

The rectifying circuit DB1 is connected to the smoothing capacitor Cin via the winding np1 as the first magnetic element, the diode D2 and the transformers T1, T2, T3. The rectifying circuit DB1 is also connected to a capacitor Cf. The smoothing capacitor Cin smoothes an output of the rectifying circuit DB1.

All of currents I_T1n1, I_T2n1, I_T3n1 flowing through the first primary windings T1n1, T2n1, T3n1 and currents I_T1n2, I_T2n2, I_T3n2 flowing through the second primary windings T1n2, T2n2, T3n2 become a current IQ1 of the switching element Q1. That is, the first primary windings T1n1, T2n1, T3n1 and the second primary windings T1n2, T2n2, T3n2 directly contribute to transmission of power.

This structure of the embodiment FIG. 2 will now be described further in detail.

In the embodiment of FIG. 2, since a high voltage VCin of the smoothing capacitor Cin is divided by the first primary windings T1n1, T2n1, T3n1 and the second primary windings T1n2, T2n2, T3n2, the number of turns in each of the first primary windings T1n1, T2n1, T3n1 can be reduced.

For example, if a flux amplitude that realizes the number of turns n1=60 in the conventional example of FIG. 1 is realized with the same core in the embodiment of FIG. 2, the number of turns n1 is 60×0.3=18 and the number of turns n2 is (60×0.7)/3=14. The total of the number of turns n1 and the number of turns n2 is 32.

However, the ratio of the voltage applied to the entire first primary windings T1n1, T2n1, T3n1 to the voltage applied to the entire second primary windings T1n2, T2n2, T3n2 is 3:7.

Therefore, a small number of turns suffices on the primary sides of the transformers T1, T2, T3. The coating on the windings is reduced and the rate of occupation by copper wires is relatively increased. As a result, in the embodiment of FIG. 2, the utilization efficiency of the transformers T1, T2, T3 rises.

In the transformers T1, T2, T3, since the connection point J between the first primary windings T1n1, T2n1, T3n1 and the second primary windings T1n2, T2n2, T3n2 is formed at the connection end to the diode D2, terminal pins in the case of mounting can be simplified.

Moreover, in the embodiment of FIG. 2, even if the transformers T1, T2, T3 have some unevenness, imbalance of magnetic fluxes is automatically restrained.

For example, when the magnetic flux of the transformer T1 has a change Δφ1, a current Iφ1 is induced at the first primary winding T1n1 of the transformer T1 by electromagnetic induction. This induced current Iφ flows through the first primary winding T2n1 of the transformer T2 and the first primary winding T3n1 of the transformer T3 and changes the magnetic flux of the transformer T2 and the magnetic flux of the transformer T3.

Therefore, as the magnetic flux of the transformer T1 increase, also the magnetic flux of the transformer T2 and the magnetic flux of the transformer T3 increase. This automatically restrains imbalance of magnetic fluxes. Therefore, the reliability of the switching power supply improves.

Similarly, when the magnetic flux of the transformer T2 has a change Δφ2, it changes the magnetic flux of the transformer T1 and the magnetic flux of the transformer T3. When the magnetic flux of the transformer T3 has a change Δφ3, it changes the magnetic flux of the transformer T1 and the magnetic flux of the transformer T2.

This effect of automatically restraining imbalance of magnetic fluxes is due to the parallel connection of the first primary windings T1n1, T2n1, T3n1 and the free flow of a current between them.

In the embodiment of FIG. 2, the connection point J between the first primary windings T1n1, T2n1, T3n1 and the second primary windings T1n2, T2n2, T3n2 is connected to the AC voltage Vac via the diode D2 and the coupled inductor L1 as the first magnetic element. This arrangement is suitable for improvement in the utilization efficiency of the transformers T1, T2, T3.

On the other hand, if auxiliary windings connected in parallel are newly provided in the transformers T1, T2, T3, the utilization efficiency of the transformers is lowered. If the secondary windings T1n3, T2n3, T3n3 of the transformers T1, T2, T3 are connected in parallel, the transformers T1, T2, T3 tend to be affected by parasitic impedance of the wirings on the secondary side, difference in forward voltage drop between diodes Drec1, Drec2, Drec3 and the like, and the load tends to be distributed by the transformers T1, T2, T3 unevenly. Therefore, this is not practical.

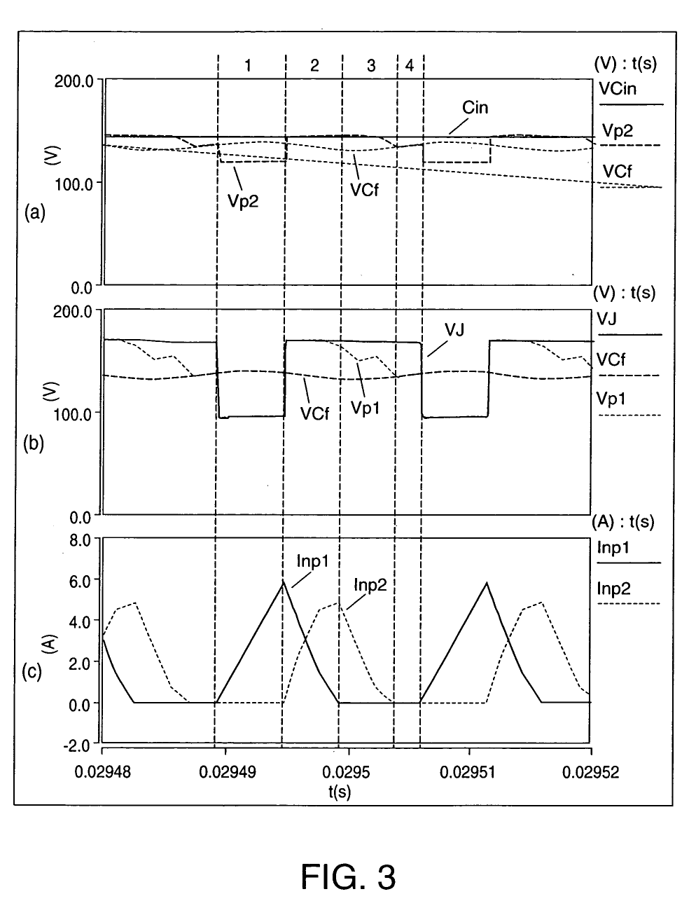

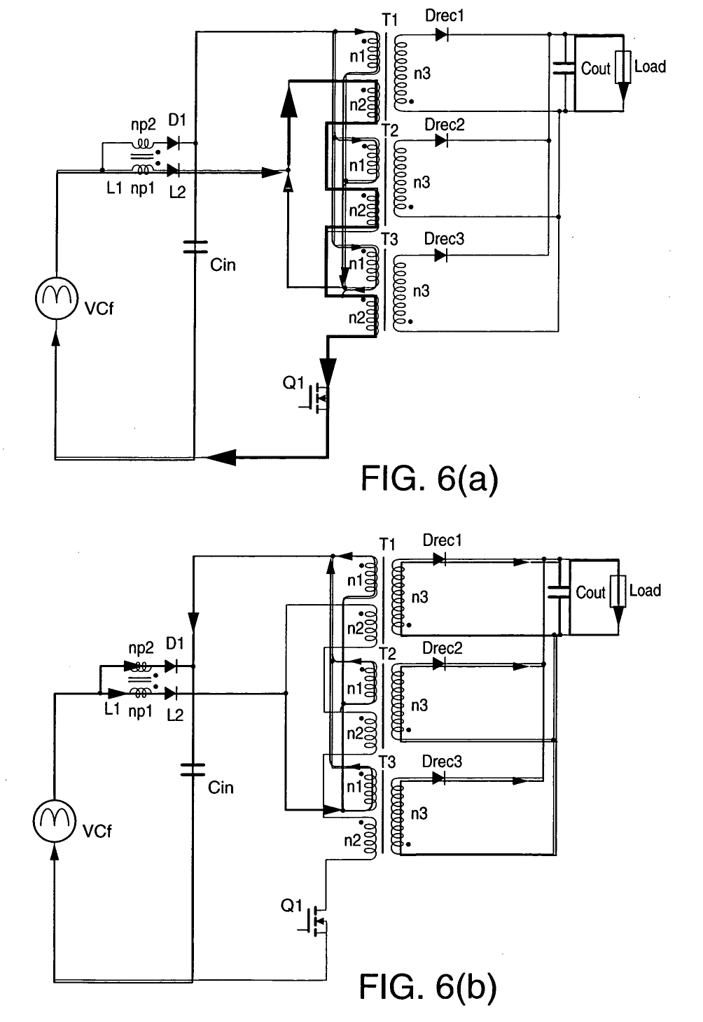

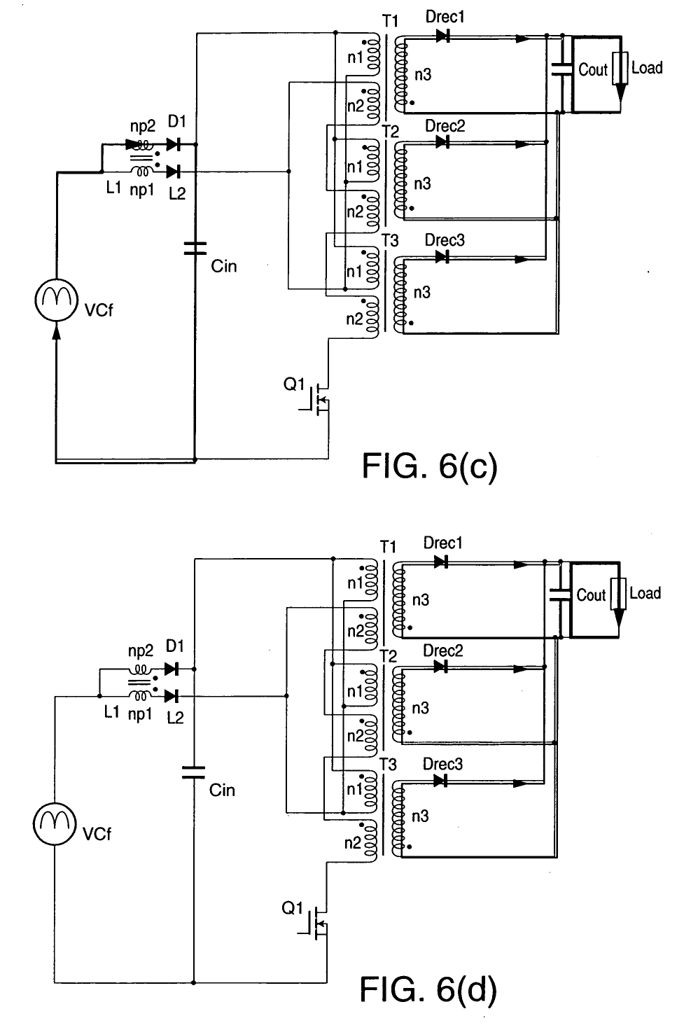

The operation in this embodiment of FIG. 2 is similar to the operation in the conventional example of FIG. 1. Power is converted at a high power factor. Hereinafter, the operation in the embodiment of FIG. 2 will be described in detail with reference to FIG. 3 to FIGS. 6A to 6D. FIGS. 3 to 5 show a waveform of each part in the embodiment of FIG. 2. FIGS. 6A to 6D are schematic diagrams showing the operations during individual periods in the embodiment of FIG. 2.

The operating state in the embodiment of FIG. 2 shifts from a period 1 to a period 7 and then again to the period 1. This operation is repeated.

In (a) of FIG. 3, a voltage VCin is a voltage of the smoothing capacitor Cin. A voltage Vp2 is a voltage at a connection point between the winding np2 of the coupled inductor L1 and the blocking diode D1. A voltage VCf is a voltage of the capacitor Cf.

In (b) of FIG. 3, a voltage VJ is a voltage at the connection point J between the first primary windings T1n1, T2n1, T3n1 and the second primary windings T1n2, T2n2, T3n2. A voltage VCf is a voltage of the capacitor Cf. A voltage Vp1 is a voltage at a connection point between the winding np1 of the coupled inductor L1 and the diode D2.

As seen from (b) of FIG. 3, the voltage VJ is a high-frequency AC voltage source.

In (c) of FIG. 3, a current Inp1 is a current of the winding np1 of the coupled inductor L1. A current Inp2 is a current of the winding np2 of the coupled inductor L1.

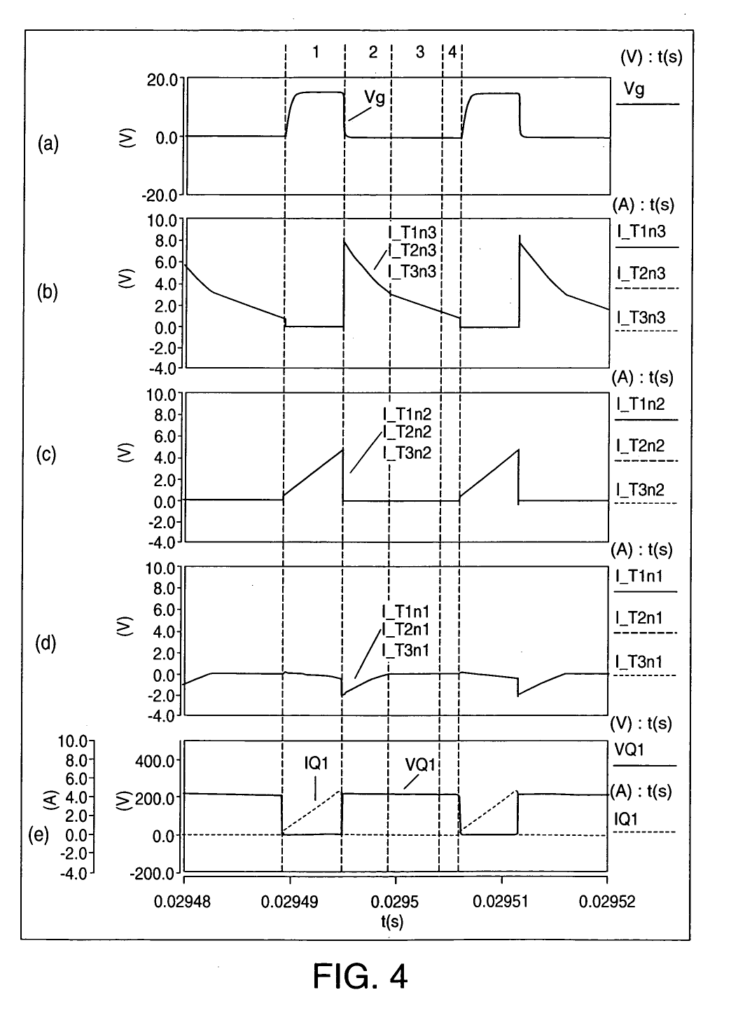

In (a) of FIG. 4, a voltage Vg is a driving voltage for the switching element Q1. In (b) of FIG. 4, a current I_T1n3 is a current of the secondary winding T1n3 of the transformer T1. A current I_T2n3 is a current of the secondary winding T2n3 of the transformer T2. A current I_T3n3 is a current of the secondary winding T3n3 of the transformer T3.

In (c) of FIG. 4, a current I_T1n2 is a current of the second primary winding T1n2 of the transformer T1. A current I_T2n2 is a current of the second primary winding T2n2 of the transformer T2. A current I_T3n2 is a current of the second primary winding T3n2 of the transformer T3.

In (d) of FIG. 4, a current I_T1n1 is a current of the first primary winding T1n1 of the transformer T1. A current I_T2n1 is a current of the first primary winding T2n1 of the transformer T2. A current I_T3n1 is a current of the first primary winding T3n1 of the transformer T3.

In (e) of FIG. 4, a voltage VQ1 is a voltage of the switching element Q1 and a current IQ1 is a current of the switching element Q1.

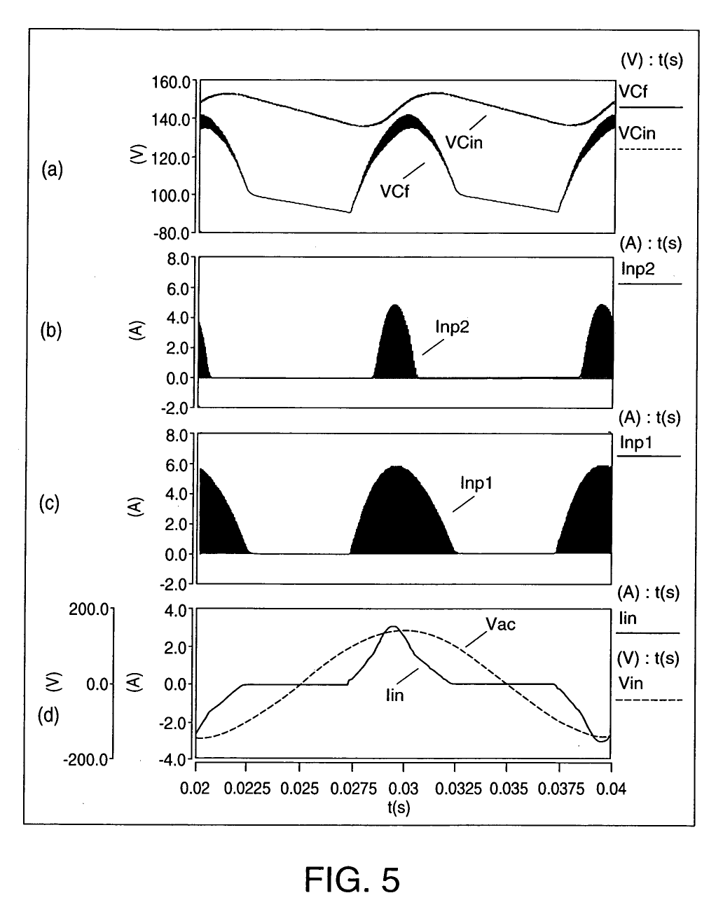

In (a) of FIG. 5, a voltage VCf is a voltage of the capacitor Cf. A voltage VCin is a voltage of the smoothing capacitor Cin. In (b) of FIG. 5, a current Inp2 is a current of the winding np2 of the coupled inductor L1. In (c) of FIG. 5, a current Inp1 is a current of the winding np1 of the coupled inductor L1.

The charts of (c) of FIG. 3, (b) of FIG. 5 and (c) of FIG. 5 show the case of a so-called inductor current discontinuous mode (DCM) where the sum of the current Inp1 and the current Inp2 is discontinuous.

In (d) of FIG. 5, a voltage Vac is the AC voltage Vac. An input current Iin is a current of the AC voltage Vac.

This (d) of FIG. 5 shows that the operation in the embodiment of FIG. 2 is performed at a high power factor.

The periods 1 to 7 will sequentially described with reference to FIGS. 3 to FIGS. 6A to 6D.

In the period 1, the switching element Q1 is on. The diode D2 is on and the block diode D1 is off. The diodes Drec1, Drec2, Drec3 are off.

In this case, the voltage VCf (AC voltage Vac) is applied to a circuit formed by the winding np1 of the coupled inductor L1 and the second primary windings T1n2, T2n2, T3n2, and this circuit is magnetically excited. The voltage VCin is applied to a circuit formed by the first primary windings T1n1, T2n1, T3n1 and the second primary windings T1n2, T2n2, T3n2, and this circuit is magnetically excited.

At the connection point J between the first primary windings T1n1, T2n1, T3n1 and the second primary windings T1n2, T2n2, T3n2, a high-frequency AC voltage VJ=(3×n2)/(n1+3×n2)×VCin is generated. Moreover, a voltage (VJ-VCf) is applied to the winding np1 of the coupled inductor L1.

As the switching element Q1 is turned off, the period 1 ends and shifts to the period 2.

In the period 2, the switching element Q1 is off. The diode D2 is on and the block diode D1 is on. The diodes Drec1, Drec2, Drec3 are on.

In this case, the current Inp1 decreases. The current Inp1 is transmitted to the secondary windings T1n3, T2n3, T3n3 via the first primary windings T1n1, T2n1, T3n1 and increases the currents I_T1n3, I_T2n3, I_T3n3. The current Inp1 also boosts the smoothing capacitor Cin. No current flows through the second primary windings T1n2, T2n2, T3n2. The current Inp2 boosts the smoothing capacitor Cin.

As the current Inp1 becomes zero and the diode D2 is turned off, the period 2 ends and shifts to the period 3.

In the period 3, the switching element Q1 is off. The diode D2 is off and the blocking diode D1 is on. The diodes Drec1, Drec2, Drec3 are on.

In this case, the current Inp2 decreases. The current Inp2 boosts the smoothing capacitor Cin. As the currents I_T1n3, I_T2n3, I_T3n3, currents for resetting the transformers T1, T2, T3 flow.

As the current Inp2 becomes zero and the block diode D1 is turned off, the period 3 ends and shifts to the period 4.

In the period 4, the switching element Q1 is off. The diode D2 is off and the block diode D1 is off. The diodes Drec1, Drec2, Drec3 are on.

In this case, the magnetic flux of the coupled inductor L1 is reset and no current flows through the circuit on the primary side.

As the switching element Q1 is turned on, the period 4 ends and shifts to the period 1.

In this manner, in the embodiment of FIG. 2, power is converted at a high power factor, as in the conventional example of FIG. 1. That is, the continuity angle of the input current Iin expands. The transformers T1, T2, T3 share the load. The first primary windings T1n1, T2n1, T3n1 and the second primary windings T1n2, T2n2, T3n2 divide the voltage VCin of the smoothing capacitor Cin.

In the embodiment of FIG. 2, preferable characteristics are shown not only in the inductor current discontinuous mode (DCM) but also in an inductor current continuous mode (CCM). This is described in detail in Patent Literature 2 (U.S. Pat. No. 6,282,103) and therefore will not be described here.

In the embodiment of FIG. 2, particularly when the coupling factor K between the winding np1 and the winding np2 of the coupled inductor L is small, power can be converted more suitably at a high power factor in the inductor current continuous mode (CCM). The detailed description of it will not be made here.

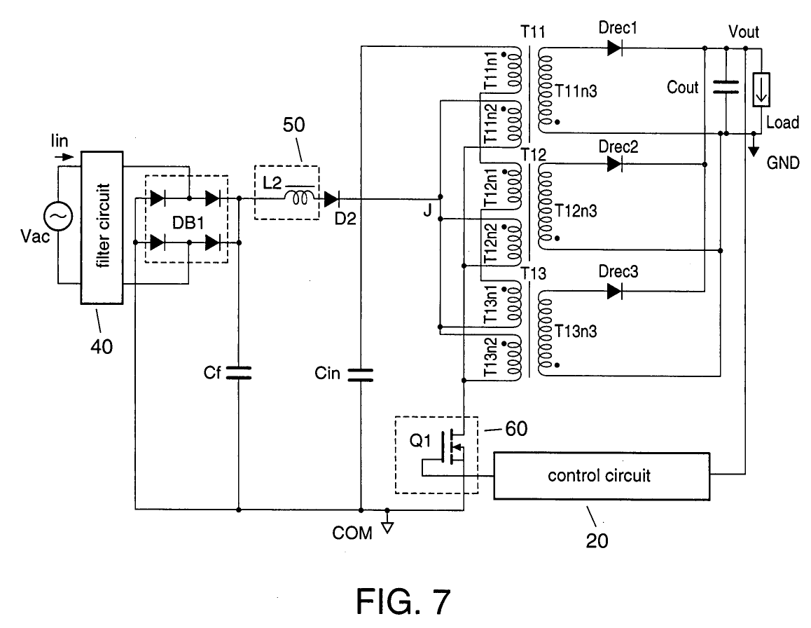

FIG. 7 is a structural view showing a second embodiment of the switching power supply according to this invention. The same elements as those in the embodiment of FIG. 2 are denoted by the same symbols and numerals and will not be described further in detail.

A first characteristic feature of the embodiment of FIG. 7 is that first primary windings T11n1, T12n1, T13n1 are connected in series while second primary windings T11n2, T12n2, T13n2 are connected in parallel.

That is, the relation of series connection and parallel connection of the above-described embodiment is reversed.

Specifically, a transformer T11 has the first primary winding T11n1, the second primary winding T11n2 and a secondary winding T11n3. A transformer T12 has the first primary winding T12n1, the second primary winding T12n2 and a secondary winding T12n3. A transformer T13 has the first primary winding T13n1, the second primary winding T13n2 and a secondary winding T13n3.

The first primary winding T11n1 of the transformer T11, the first primary winding T12n1 of the transformer T12 and the first primary winding T13n1 of the transformer T13 are connected in series.

The second primary winding T11n2 of the transformer T11, the second primary winding T12n2 of the transformer T12 and the second primary winding T13n2 of the transformer T13 are connected in parallel.

The number of turns in each of the first primary windings T11n1, T12n1, T13n1 is set to be the number of turns n1, and the number of turns in each of the second primary windings T11n2, T12n2, T13n2 is set to be the number of turns n2. The transformers T11, T12, T13 thus have substantially the same properties.

The first primary windings T11n1, T12n1, T13n1 and the second primary windings T11n2, T12n2, T13n2 are connected in series. A switching element Q1 and a smoothing capacitor Cin are connected in series with these windings.

Therefore, when the switching element Q1 is on, the ratio of a voltage applied to the first primary windings T11n1, T12n1, T13n1 to a voltage applied to the second primary windings T11n2, T12n2, T13n2 is n1:(n2/3).

Also in this case, the first primary windings T11n1, T12n1, T13n1 and the second primary windings T11n2, T12n2, T13n2 are connected in series, as in the embodiment of FIG. 2. As a result, in the embodiment of FIG. 7, the utilization efficiency of the transformers T11, T12, T13 improves.

For example, if a flux amplitude that realizes the number of turns n1=60 in the conventional example of FIG. 1 is realized with the same core in the embodiment of FIG. 7, the number of turns n1 is (60×0.3)/3=6 and the number of turns n2 is 60×0.7=42. The total of the number of turns n1 and the number of turns n2 is 48.

However, the ratio of the voltage applied to the entire first primary windings T11n1, T12n1, T13n1 to the voltage applied to the entire second primary windings T11n2, T12n2, T13n2 is 3:7.

Therefore, in the embodiment of FIG. 7, a small number of turns suffices on the primary sides of the transformers T11, T12, T13, as in the embodiment of FIG. 2. The coating on the windings is reduced and the rate of occupation by copper wires is relatively increased. As a result, in the embodiment of FIG. 7, the utilization efficiency of the transformers T11, T12, T13 rises.

In the embodiment of FIG. 2 and the embodiment of FIG. 7, a preferable power factor is realized when the ratio of the voltage applied to the entire first primary windings (first primary windings T1n1, T2n1, T3n1 and first primary windings T11n1, T12n1, T13n1) to the voltage applied to the entire second primary windings (second primary windings T1n2, T2n2, T3n2 and second primary windings T11n2, T12n2, T13n2) is approximately 20:80 to approximately 50:50.

Therefore, the utilization efficiency of the transformers (transformers T1, T2, T3 and transformers T11, T12, T13) is higher in the embodiment of FIG. 2 where the second primary windings T1n2, T2n2, T3n2 are connected in series than in the embodiment of FIG. 7 where the first primary windings T11n1, T12n1, T13n1 are connected in series.

A second characteristic feature of the embodiment of FIG. 7 is that an inductor L2 is provided, which is a first magnetic element arranged between a connection point J between the first primary windings T11n1, T12n1, T13n1 and the second primary windings T11n2, T12n2, T13n2, and an AC voltage Vac, thus omitting an element equivalent to the block diode D1 of the embodiment of FIG. 2.

In this embodiment of FIG. 7, the number of components is reduced and the cost is lowered.

An equivalent result can be realized by replacing the inductor L2 with a leakage inductance in the first primary windings T11n1, T12n1, T13n1 and the second primary windings T11n2, T12n2, T13n2 of the transformers T11, T12, T13.

The inductor L2 forms an inductance circuit 50 and the switching element Q1 forms a switching circuit 60.

Also with such a structure, an operation similar to that in the embodiment of FIG. 2 is realized and power can be converted at a high power factor in the embodiment of FIG. 7. In the embodiment of FIG. 7, the operation in the inductor current discontinuous mode (DCM) can be performed in a broader range. The detailed description of it will not be made here.

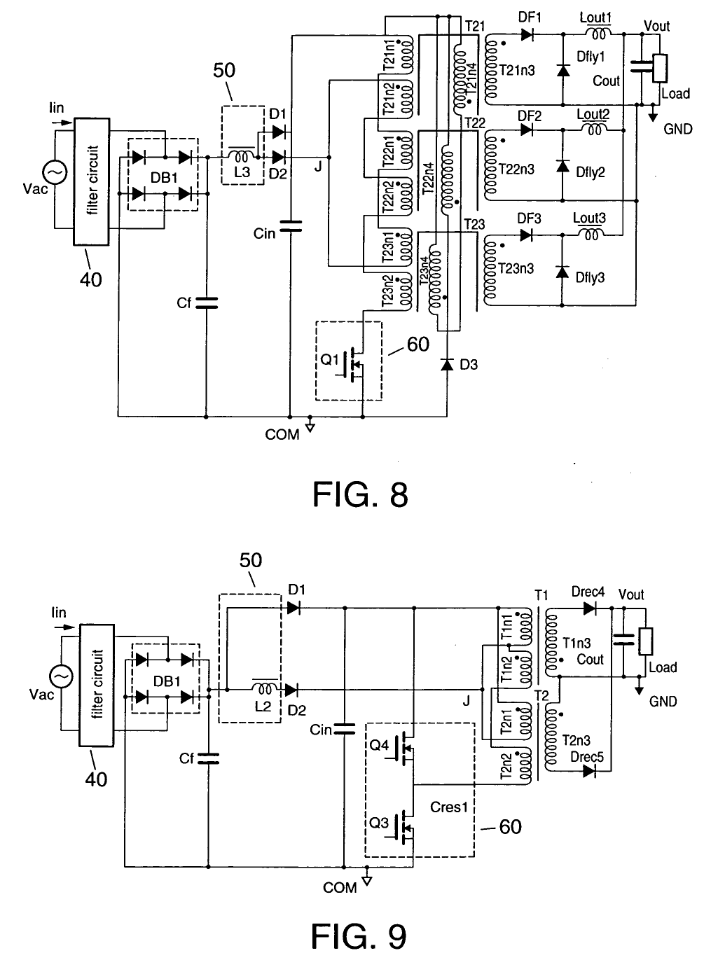

FIG. 8 is a structural view showing a third embodiment of the switching power supply according to this invention. The same elements as those in the embodiment of FIG. 2 and the embodiment of FIG. 7 are denoted by the same symbols and numerals and will not be described further in detail.

A first characteristic feature of the embodiment of FIG. 8 is that first primary windings T21n1, T22n1, T23n1 are connected in series, second primary windings T21n2, T22n2, T23n2 are connected in series, and transformers T21, T22, T23 have reset windings T21n4, T22n4, T23n4 that are connected in parallel.

Specifically, the transformer T21 has the first primary winding T21n1, the second primary winding T21n2, a secondary winding T21n3 and the reset winding T21n4.

The transformer T22 has the first primary winding T22n1, the second primary winding T22n2, a secondary winding T22n3 and the reset winding T22n4.

The transformer T23 has the first primary winding T23n1, the second primary winding T23n2, a secondary winding T23n3 and the reset winding T23n4.

The first primary winding T21n1 of the transformer T21, the first primary winding T22n1 of the transformer T22 and the first primary winding T23n1 of the transformer T23 are connected in series.

The second primary winding T21n2 of the transformer T21, the second primary winding T22n2 of the transformer T22 and the second primary winding T23n2 of the transformer T23 are connected in series.

The reset winding T21n4 of the transformer T21, the reset winding T22n4 of the transformer T22 and the reset winding T23n4 of the transformer T23 are connected in parallel.

The reset windings T21n4, T22n4, T23n4 are connected to a smoothing capacitor Cin via a diode D3.

The number of turns in each of the first primary windings T21n1, T22n1, T23n1 is set to be the number of turns n1, and the number of turns in each of the second primary windings T21n2, T22n2, T23n2 is set to be the number of turns n2. The transformers T21, T22, T23 thus have substantially the same properties.

The first primary windings T21n1, T22n1, T23n1 and the second primary windings T21n2, T22n2, T23n2 are connected in series. A switching element Q1 and the smoothing capacitor Cin are connected in series with these windings.

Also in this case, the first primary windings T21n1, T22n1, T23n1 and the second primary windings T21n2, T22n2, T23n2 are connected in series, as in the embodiment of FIG. 2 and the embodiment of FIG. 7. As a result, in the embodiment of FIG. 8, the utilization efficiency of the transformers T21, T22, T23 improves.

Moreover, since the reset windings T21n4, T22n4, T23n4 are connected in parallel and a current can freely flow through these windings, even if the transformers T21, T22, T23 have some unevenness, imbalance of magnetic fluxes is automatically restrained, as in the embodiment of FIG. 2.

A second characteristic feature of the embodiment of FIG. 8 is that an AC voltage Vac is connected to one end of an inductor L3 via a filter circuit 40 and a rectifying circuit DB1, the other end of the inductor L3 is connected to one end of a diode D2 and one end of a blocking diode D1, the other end of the diode D2 is connected to a connection point J between the first primary windings T21n1, T22n1, T23n1 and the second primary windings T21n2, T22n2, T23n2, and the other end of the blocking diode D1 is connected to the smoothing capacitor Cin.

The inductor L3 forms an inductance circuit 50. The inductance circuit 50 is connected between the AC voltage Vac and a high-frequency AC voltage source generated by an on/off operation at the connection point J between the first primary windings T21n1, T22n1, T23n1 and the second primary windings T21n2, T22n2, T23n2. Moreover, the inductance circuit 50 is connected between the rectifying circuit DB1 and the smoothing capacitor Cin.

The inductor L3 is a first magnetic element connected between the connection point J between the first primary windings T21n1, T22n1, T23n1 and the second primary windings T21n2, T22n2, T23n2, and the AC voltage Vac, and is also a second magnetic element connected between the rectifying circuit DB1 and the smoothing capacitor Cin. That is, the inductor L3 serves as both a first magnetic element and a second magnetic element.

Also with such a structure, an operation similar to that in the embodiment of FIG. 2 and the embodiment of FIG. 7 is realized and power is converted at a high power factor in the embodiment of FIG. 8. The detailed description of it will not be made here.

A third characteristic feature of the embodiment of FIG. 8 is that power is converted by a forward type system. On the other hand, in the embodiment of FIG. 2 and the embodiment of FIG. 7, power is converted by a flyback type system.

Specifically, the secondary winding T21n3 of the transformer T21 is connected to a diode DF1 and a diode Dfly1 and is further connected to an inductor Lout1. The secondary winding T22n3 of the transformer T22 is connected to a diode DF2 and a diode Dfly2 and is further connected to an inductor Lout2. The secondary winding T23n3 of the transformer T23 is connected to a diode DF3 and a diode Dfly 3 and is further connected to an inductor Lout3. The inductors Lout1, Lout2, Lout3 are connected in parallel and are connected to a capacitor Cout and a load Load.

Voltages induced at the secondary windings T21n3, T22n3, T23n3 are rectified by the diodes DF1, DF2, DF3, Dfly1, Dfly2, Dfly3 and smoothed by the inductors Lout1, Lout2, Lout3 and the capacitor Cout, thus becoming an output voltage Vout to supply power to the load Load.

In the embodiment of FIG. 8, the reset windings T21n4, T22n4, T23n4 for resetting the cores of the transformers T21, T22, T23 are provided. The reset windings T21n4, T22n4, T23n4 are connected in the direction of resetting the transformers T21, T22, T23, as shown in FIG. 8.

That is, the reset windings T21n4, T22n4, T23n4 are connected so that a voltage of the smoothing capacitor Cin is applied in the resetting direction when a switching circuit 60 is off.

The cores of the transformers T21, T22, T23 are magnetically excited when the switching circuit 60 is on. The cores of the transformers T21, T22, T23 are reset by the reset windings when the switching circuit 60 is off. Since the reset windings T21n4, T22n4, T23n4 do not directly contribute to transmission of power, thin windings with small current capacitance are used for these windings.

In this embodiment of FIG. 8, power is converted at a high power factor. The detailed description of it will not be made here.

FIG. 9 is a structural view showing a fourth embodiment of the switching power supply according to this invention. The same elements as those in the embodiment of FIG. 2 are denoted by the same symbols and numerals and will not be described further in detail.

A first characteristic feature of the embodiment of FIG. 9 is that an AC voltage Vac is connected to one end of a inductor L2 via a filter circuit 40 and a rectifying circuit DB1, the other end of the inductor L2 is connected to a connection point J between first primary windings T1n1, T2n1 and second primary windings T1n2, T2n2 via a diode D2, and a blocking diode D1 is connected between the rectifying circuit DB1 and a smoothing capacitor Cin.

The inductor L2 forms an inductance circuit 50. The inductance circuit 50 is connected between the AC voltage Vac and a high-frequency AC voltage source generated by an on/off operation at the connection point J between the first primary windings T1n1, T2n1 and the second primary windings T1n2, T2n2. The inductance circuit 50 is also connected between the rectifying circuit DB1 and the smoothing capacitor Cin.

Also with such a structure, an operation similar to that in the embodiment of FIG. 2 is realized and power is converted at a high power factor in the embodiment of FIG. 9. Moreover, in the embodiment of FIG. 9, excessive rise in voltage VCin of the smoothing capacitor Cin can be restrained. The detailed description of it will not be made here.

A second characteristic feature of the embodiment of FIG. 9 is that a switching element Q3, a switching element Q4 and a capacitor Cres1 form a switching circuit 60.

Specifically, a series circuit formed by the switching element Q3 and the switching element Q4 is connected to the smoothing capacitor Cin. A connection point between the switching element Q3 and the switching element Q4 is connected to a transformer T1 and a transformer T2 via the capacitor Cres1.

The switching element Q3 and the switching element Q4 are turned on/off in a complementary manner. The connection point between the switching element Q3 and the switching element Q4 thus becomes a high-frequency AC voltage source. Also the connection point between the capacitor Cres1 and the transformers T1, T2 becomes a high-frequency AC voltage source. The connection point J between the first primary windings T1n1, T2n1 and the second primary windings T1n2, T2n2 becomes a high-frequency AC voltage, too.

Therefore, also with such a structure, an operation similar to that in the embodiment of FIG. 2 is realized and power is converted at a high power factor in the embodiment of FIG. 9.

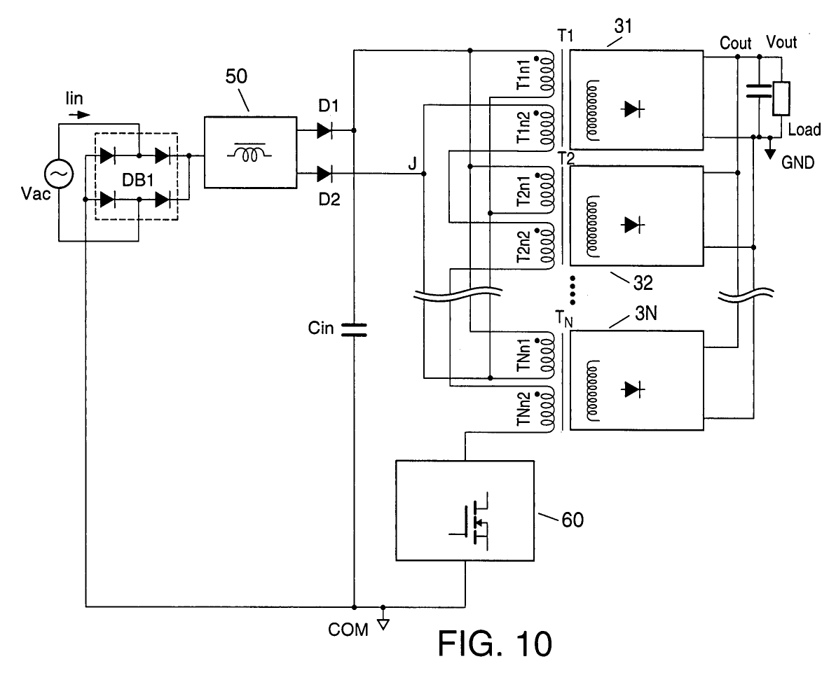

FIG. 10 is a structural view showing a fifth embodiment of the switching power supply according to this invention. The same elements as those in the embodiment of FIG. 2 are denoted by the same symbols and numerals and will not be described further in detail.

A characteristic feature of the embodiment of FIG. 10 is that the embodiment of FIG. 2 and the embodiment of FIG. 9 are generalized and used for various applications.

Specifically, in the embodiment of FIG. 10, transformers T1, T2, . . . , TN are provided.

Secondary sides of the transformers T1, T2, . . . , TN are connected to output circuits 31, 32, . . . , 3N, respectively. The output circuits 31, 32, . . . , 3N are formed by secondary windings of the transformers T1, T2, . . . , TN and rectifying devices.

A connection point J between first primary windings T1n1, T2n1, . . . , TNn1 and second primary windings T1n2, T2n2, . . . , TNn2 is connected to an AC voltage Vac via a diode D2 and an inductance circuit 50.

A smoothing capacitor Cin is connected to a rectifying circuit DB1 via a blocking diode D1 and the inductance circuit 50.

The inductance circuit 50 may be the coupled inductor L1 described in the embodiment of FIG. 2 or may be any of the inductance circuits described in the embodiments of FIGS. 7, 8 and 9. Other modifications can also be made.

The first primary windings T1n1, T2n1, . . . , TNn1, the second primary windings T1n2, T2n2, . . . , TNn2, a switching circuit 60 and the smoothing capacitor Cin are connected in series.

The switching circuit 60 may be the switching element Q1 described in the embodiment of FIG. 2 or may be the switching circuit described in the embodiment of FIG. 9. Other modifications can also be made.

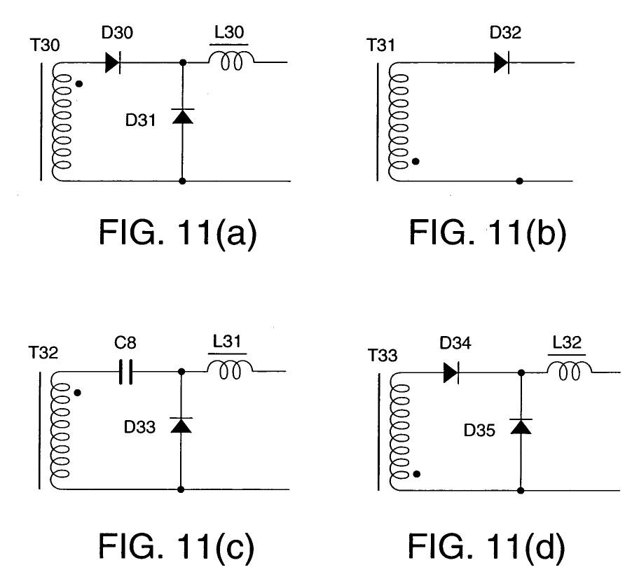

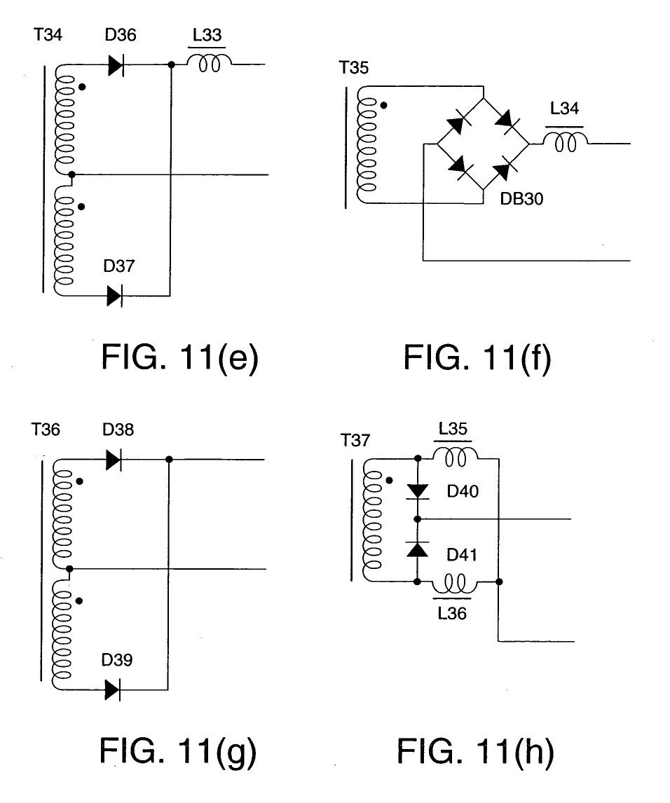

FIGS. 11A to 11H are structural views showing specific examples of the output circuits 31, 32, . . . , 3N in the embodiment of FIG. 10. FIG. 11A shows a forward type. FIG. 11B shows a flyback type. FIG. 11C shows a Zeta type. FIG. 11D shows a fly-forward type. FIG. 11E shows a center tapped type. FIG. 11F shows a bridge type. FIG. 11G shows an inductanceless center tapped type. FIG. 11H shows a current doubler type. Moreover, modifications can be made by combining these types.

For example, the flyback type shown in FIG. 11B is employed in the embodiment of FIG. 2 and the embodiment of FIG. 7. The forward type shown in FIG. 11A is employed in the embodiment of FIG. 8.

Also in this embodiment of FIG. 10, an operation similar to that in the embodiment of FIG. 2 is realized and power is converted at a high power factor. The detailed description of it will not be made here.

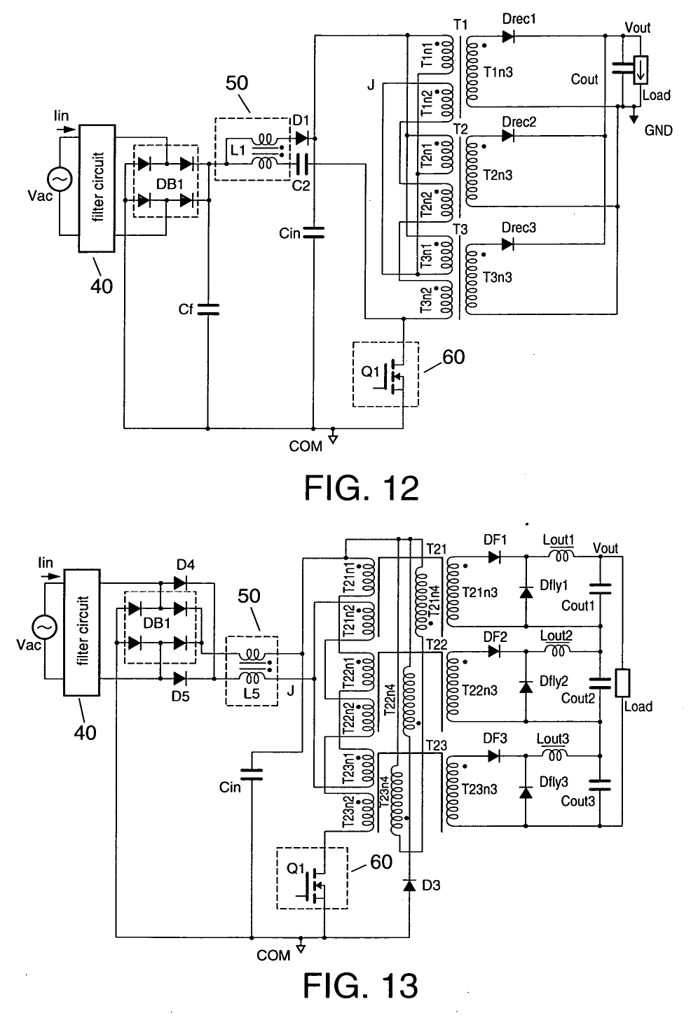

FIG. 12 is a structural view showing a sixth embodiment of the switching power supply according to this invention. The same elements as those in the embodiment of FIG. 2 are denoted by the same symbols and numerals and will not be described further in detail.

A first characteristic feature of the embodiment of FIG. 12 is that a capacitor C2 is provided instead of the diode D2 of the embodiment of FIG. 2.

Specifically, the capacitor C2 is connected in series with a coupled inductor L1, which is a first magnetic element. The coupled inductor L1 is an inductance circuit 50.

A connection point J between first primary windings T1n1, T2n1, T3n1 and second primary windings T1n2, T2n2, T3n2 is connected to an AC voltage Vac via the second primary windings T1n2, T2n2, T3n2, the capacitor C2, the coupled inductor L1 as the first magnetic element, a diode in a rectifying circuit DB1 and a filter circuit 40.

A second characteristic feature of the embodiment of FIG. 12 is that one end of the capacitor C2 is connected to a connection point between transformers T1, T2, T3 and a switching circuit 60.

Specifically, the connection point between the transformers T1, T2, T3 and a switching element Q1 becomes a high-frequency AC voltage source as the switching circuit is turned on/off. Therefore, also the connection point between the coupled inductor L1 and the capacitor C2 becomes a high-frequency AC voltage source as the switching circuit is turned on/off.

Between the AC voltage Vac and the above-described high-frequency AC voltage source, a series circuit formed by the diode of the rectifying circuit DB1 and the coupled inductor L1 as the first magnetic element is connected.

Also in this embodiment of FIG. 12, an operation similar to that in the embodiment of FIG. 2 is realized and power is converted at a high power factor. The detailed description of it will not be made here.

FIG. 13 is a structural view showing seventh embodiment of the switching power supply according to this invention. The same elements as those in the embodiment of FIG. 2 and the embodiment of FIG. 8 are denoted by the same symbols and numerals and will not be described further in detail.

A characteristic feature of the embodiment of FIG. 13 is that a diode D4 and a diode D5 are provided instead of the diode D2 of the embodiment of FIG. 2.

A diode in a rectifying circuit DB1 is substituted for the blocking diode D1 of the embodiment of FIG. 2.

Specifically, one end of the diode D4 is connected to an AC voltage Vac via a filter circuit 40, and the other end of the diode D4 is connected to a connection point J between first primary windings T21n1, T22n1, T23n1 and second primary windings T21n2, T22n2, T23n2 via an inductance circuit 50.

In the embodiment of FIG. 13, the diode that is in the rectifying circuit DB1 and has its cathode connected to the inductance circuit 50 is equivalent to the blocking diode D1 described in the embodiment of FIG. 2.

One end of the diode D5 is connected to the AC voltage Vac via the filter circuit 40, and the other end of the diode D5 is connected to the connection point J between the first primary windings T21n1, T22n1, T23n1 and the second primary windings T21n2, T22n2, T23n2 via the inductance circuit 50.

The inductance circuit 50 is formed by a coupled inductor L5.

The connection point J between the first primary windings T21n1, T22n1, T23n1 and the second primary windings T21n2, T22n2, T23n2 is connected to the AC voltage Vac via the diode D4, the diode D5, the inductance circuit 50 and the filter circuit 40.

Also in this embodiment of FIG. 13, an operation similar to that in the embodiment of FIG. 2 is realized and power is converted at a high power factor. The detailed description of it will not be made here.

Moreover, in the embodiment of FIG. 13, since a current of the diode D4 and a current of the diode D5 do not flow through the rectifying circuit DB1, the loss due to forward voltage drop is small. This is preferable.

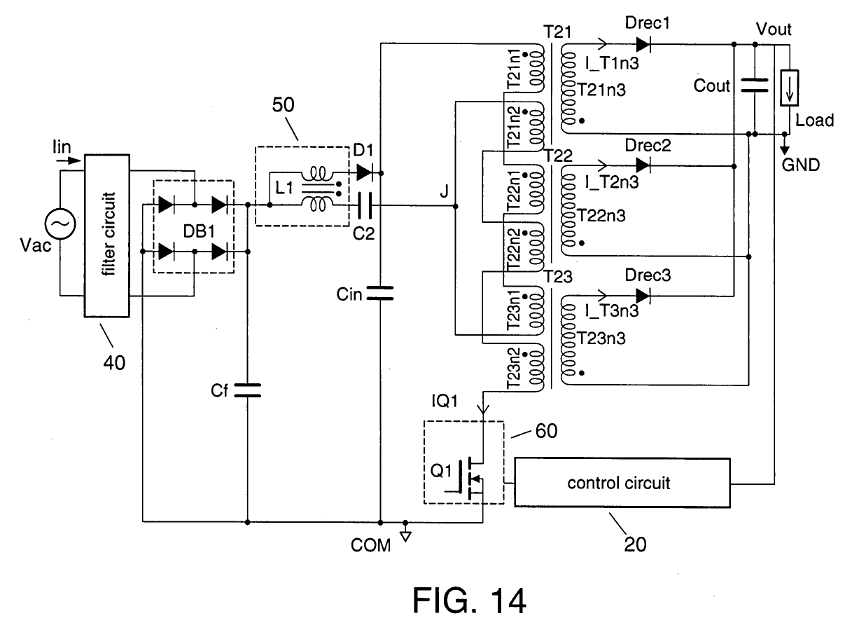

FIG. 14 is a structural view showing an eighth embodiment of the switching power supply according to this invention. The same elements as those in the embodiment of FIG. 2 are denoted by the same symbols and numerals and will not be described further in detail.

A first characteristic feature of the embodiment of FIG. 14 is that first primary windings T21n1, T22n1, T23n1 are connected in series and that second primary windings T21n2, T22n2, T23n2 are connected in series.

Specifically, a transformer T21 has the first primary winding T21n1, the second primary winding T21n2 and a secondary winding T21n3. A transformer T22 has the first primary winding T22n1, the second primary winding T22n2 and a secondary winding T22n3. A transformer T23 has the first primary winding T23n1, the second primary winding T23n2 and a secondary winding T23n3.

The first primary winding T21n1 of the transformer T21, the first primary winding T22n1 of the transformer T22 and the first primary winding T23n1 of the transformer T23 are connected in series.

The second primary winding T21n2 of the transformer T21, the second primary winding T22n2 of the transformer T22 and the second primary winding T23n2 of the transformer T23 are connected in series.

The number of turns in each of the first primary windings T21n1, T22n1, T23n1 is set to be the number of turns n1, and the number of turns in each of the second primary windings T21n2, T22n2, T23n2 is set to be the number of turns n2. The number of turns in each of the secondary windings T21n3, T22n3, T23n3 is set to be the number of turns n3. The transformers T21, T22, T23 thus have substantially the same properties.

The first primary windings T21n1, T22n1, T23n1 and the second primary windings T21n2, T22n2, T23n2 are connected in series. A switching element Q1 and a smoothing capacitor Cin are connected in series with these windings.

Also in this case, in the embodiment of FIG. 14, the utilization efficiency of the transformers T21, T22, T23 improves, as in the embodiment of FIG. 2 and the embodiment of FIG. 7.

For example, if a flux amplitude that realizes the number of turns n1=60 in the conventional example of FIG. 1 is realized with the same core in the embodiment of FIG. 14, the number of turns n1 is (60×0.3)/3=6 and the number of turns n2 is (60×0.7)/3=14. The total of the number of turns n1 and the number of turns n2 is 20.

However, the ratio of a voltage applied to the entire first primary windings T21n1, T22n1, T23n1 to a voltage applied to the entire second primary windings T21n2, T22n2, T23n2 is 3:7.

Therefore, in the embodiment of FIG. 14, a small number of turns suffices on the primary sides of the transformers T21, T22, T23, as in the embodiment of FIG. 2. The coating on the windings is reduced and the rate of occupation by copper wires is relatively increased. As a result, in the embodiment of FIG. 14, the utilization efficiency of the transformers T21, T22, T23 rises.

If a modification is made to increase the number of transformers in the embodiment of FIG. 14, the utilization efficiency of the transformers can be improved further.

However, in the embodiment of FIG. 14, unlike the embodiment of FIG. 2, when the transformers T21, T22, T23 have some unevenness, imbalance of magnetic fluxes cannot be automatically restrained.

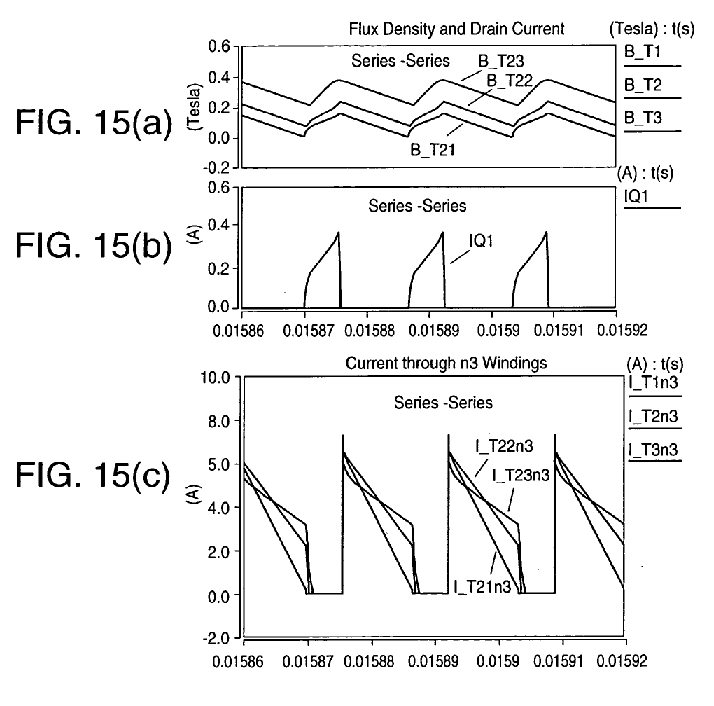

The operation in the embodiment of FIG. 14 will now be described with reference to FIG. 15. FIG. 15 shows an operating waveform of each part in an unbalanced state in the embodiment of FIG. 13. However, an extremely unbalanced state is assumed such that the ratio of the inductance of the transformer T21:inductance of the transformer T22:inductance of the transformer T23 is 1:2:3. A current of a load Load is 8A. The ratio of the numbers of turns n1:n2:n3 is 7:13:12.

In (a) of FIG. 15, a magnetic flux density B_T21 is a magnetic flux density of the core of the transformer T21. A magnetic flux density B_T22 is a magnetic flux density of the core of the transformer T22. A magnetic flux density B_T23 is a magnetic flux density of the core of the transformer T23.

In (b) of FIG. 15, a current IQ1 is a current flowing through a switching circuit 60.

In (c) of FIG. 15, a current I_T21n3 is a current of the secondary winding T21n3 of the transformer T21. A current I_T22n3 is a current of the secondary winding T22n3 of the transformer T22. A current I_T23n3 is a current of the secondary winding T23n3 of the transformer T23.

The charts (a) to (c) of FIG. 15 show that the core of the transformer T23 is partly saturated. However, since the first primary windings T21n1, T22n1, T23n1 and the second primary windings T21n2, T22n2, T23n2 are connected in series, the current IQ1 of the switching circuit 60 gently rises even if partial saturation of the core occurs. This is because the other unsaturated cores prevent the inductance of the entire first primary windings T21n1, T22n1, T23n1 from being extremely lowered.

Therefore, reliability of the elements can be properly secured particularly when the number of series connections of the transformers is large.

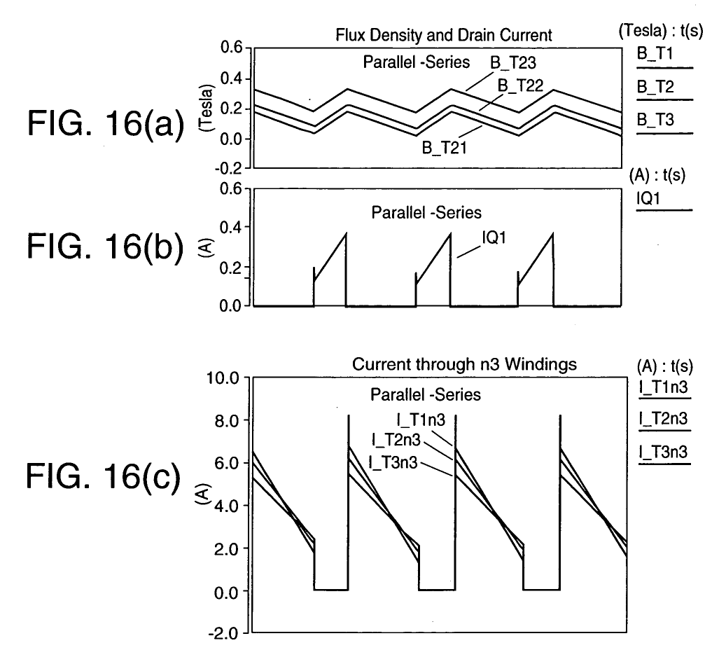

Meanwhile, the operation in the embodiment of FIG. 2 under conditions equivalent to those of FIG. 15 will be described with reference to FIG. 16. FIG. 16 shows an operating waveform of each part in an unbalanced state in the embodiment of FIG. 2. In FIG. 16, as in the case of FIG. 15, an extremely unbalanced state is assumed such that the ratio of the inductance of the transformer T1:inductance of the transformer T2:inductance of the transformer T3 is 1:2:3. The current of the load Load is 8A. The ratio of the numbers of turns n1:n2:n3 is 21:13:12.

In (a) of FIG. 16, a magnetic flux density B_T1 is a magnetic flux density of the core of the transformer T1. A magnetic flux density B_T2 is a magnetic flux density of the core of the transformer T2. A magnetic flux density B_T3 is a magnetic flux density of the core of the transformer T3.

In (b) of FIG. 16, a current IQ1 is a current flowing through the switching circuit 60.

In (c) of FIG. 16, a current I_T1n3 is a current of the secondary winding T1n3 of the transformer T1. A current I_T2n3 is a current of the secondary winding T2n3 of the transformer T2. A current I_T3n3 is a current of the secondary winding T3n3 of the transformer T3.

The charts (a) to (c) of FIG. 16 show that the core of the transformer T3 is not saturated. This is because in the embodiment of FIG. 2, the effect of automatically restraining the imbalance of magnetic fluxes also restrains the saturation of the core.

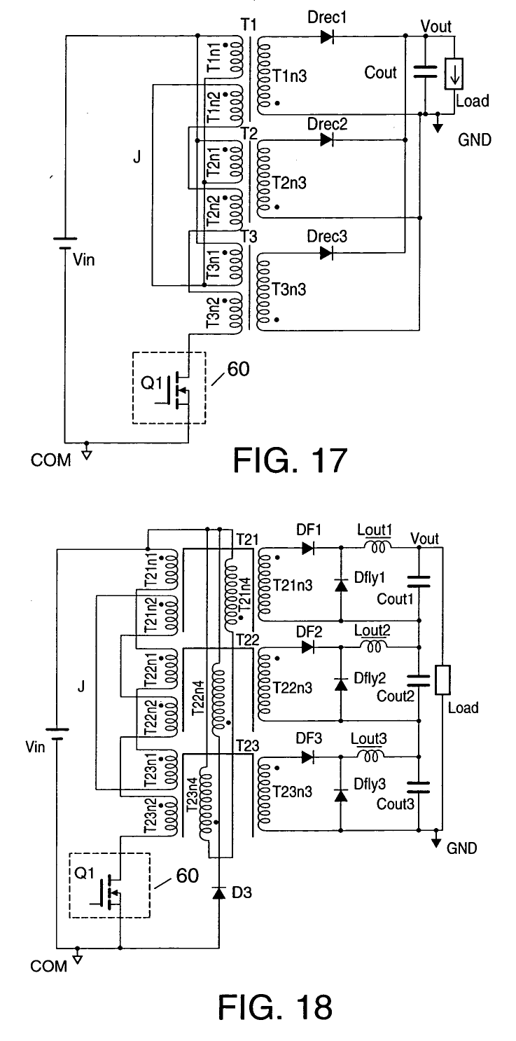

FIG. 17 shows a structural view showing a ninth embodiment of the switching power supply according to this invention. The same elements as those in the embodiment of FIG. 2 are denoted by the same symbols and numerals and will not be described further in detail.

A characteristic feature of the embodiment of FIG. 17 is that a DC voltage Vin is provided instead of the smoothing capacitor Cin of the embodiment of FIG. 2.

Specifically, first primary windings T1n1, T2n1, T3n1 and second primary windings T1n2, T2n2, T3n2 are connected in series. A switching element Q1 and the DC voltage Vin are connected in series with these windings.

Moreover, in the embodiment of FIG. 17, high utilization efficiency of transformers T1, T2, T3 is realized, and even if the transformers T1, T2, T3 have some unevenness, imbalance of magnetic fluxes is automatically restrained, as in the embodiment of FIG. 2. Therefore, a preferable switching power supply can be provided.

FIG. 18 is a structural view showing a tenth embodiment of the switching power supply according to this invention. The same elements as those in the embodiment of FIG. 8 are denoted by the same symbols and numerals and will not be described further in detail.

A characteristic feature of the embodiment of FIG. 18 is that a DC voltage Vin is provided instead of the smoothing capacitor Cin of the embodiment of FIG. 8.

Specifically, in the embodiment of FIG. 18, first primary windings T21n1, T22n1, T23n1 and second primary windings T21n2, T22n2, T23n2 are connected in series, as in the embodiment of FIG. 17. A switching element Q1 and the DC voltage Vin are connected in series with these windings. Moreover, transformers T21, T22, T23 have reset windings T21n4, T22n4, T23n4 that are connected in parallel.

From a different viewpoint, in the embodiment of FIG. 18, the series connection of the first primary windings T21n1, T22n1, T23n1 and the second primary windings T21n2, T22n2, T23n2 can be used as second primary windings (T21n1, T22n1, T23n1, T21n2, T22n2, T23n2), and the reset windings T21n4, T22n4, T23n4 can be used as first primary windings (T21n4, T22n4, T23n4).

In this case, the first primary windings (T21n4, T22n4, T23n4) are connected as the reset windings T21n4, T22n4, T23n4 so that a voltage is applied thereto in the direction of resetting the transformers T21, T22, T23 when the switching circuit is off.

Moreover, in the embodiment of FIG. 18, high utilization efficiency of the transformers T21, T22, T23 is realized, and even if the transformers T21, T22, T23 have some unevenness, imbalance of magnetic fluxes is automatically restrained, as in the embodiment of FIG. 17. Therefore, a preferable switching power supply can be provided.

As described above, according to the present invention, a switching power supply suitable for miniaturization can be provided. Also a switching power supply suitable for reduction in thickness can be provided.

What is claimed is:

1. A switching power supply comprising a rectifying circuit for rectifying an AC voltage, a smoothing capacitor for smoothing an output of the rectifying circuit, and plural transformers to which a voltage of the smoothing capacitor is applied by turning on/off of a switching circuit and which induce a voltage to be an output at secondary windings,
wherein the transformers have first primary windings connected in parallel and second primary windings connected in series,
the first primary windings, the second primary windings, the switching circuit and the smoothing capacitor are connected in series, and
a connection point between the first primary windings and the second primary windings is connected to the AC voltage via a diode and a first magnetic element.

2. The switching power supply as claimed in claim 1, further comprising a blocking diode for connecting the rectifying circuit with the smoothing capacitor.

3. The switching power supply as claimed in claim 2, further comprising a capacitor connected in series with the first magnetic element.

4. The switching power supply as claimed in claim 2, further comprising a second magnetic element connected in series with the blocking diode.

5. The switching power supply as claimed in claim 4, wherein the first magnetic element and the second magnetic element are magnetically coupled.

6. The switching power supply as claimed in claim 1, wherein the first primary windings are connected to the smoothing capacitor, and the second primary windings are connected to the switching circuit.

7. A switching power supply comprising a rectifying circuit for rectifying an AC voltage, a smoothing capacitor for smoothing an output of the rectifying circuit, and plural transformers to which a voltage of the smoothing capacitor is applied by turning on/off of a switching circuit and which induce a voltage to be an output at secondary windings,
wherein the transformers have first primary windings connected in series and second primary windings connected in series,
the first primary windings, the second primary windings, the switching circuit and the smoothing capacitor are connected in series, and
a connection point between the first primary windings and the second primary windings is connected to the AC voltage via a diode and a first magnetic element.

8. The switching power supply as claimed in claim 7, wherein the transformers have reset windings connected in parallel.

9. A switching power supply comprising a rectifying circuit for rectifying an AC voltage, a smoothing capacitor for smoothing an output of the rectifying circuit, plural transformers to which a voltage of the smoothing capacitor is applied by turning on/off of a switching circuit and which induce a voltage to be an output at secondary windings, and a series circuit formed by a diode and a first magnetic element connected between the AC voltage and a high-frequency AC voltage source generated by the turning on/off,
wherein the transformers have first primary windings connected in parallel and second primary windings connected in series, and
the first primary windings, the second primary windings, the switching circuit and the smoothing capacitor are connected in series.

10. A switching power supply comprising a rectifying circuit for rectifying an AC voltage, a smoothing capacitor for smoothing an output of the rectifying circuit, plural transformers to which a voltage of the smoothing capacitor is applied by turning on/off of a switching circuit and which induce a voltage to be an output at secondary windings, and a series circuit formed by a diode and a first magnetic element connected between the AC voltage and a high-frequency AC voltage source generated by the turning on/off,
wherein the transformers have first primary windings connected in series and second primary windings connected in series, and
the first primary windings, the second primary windings, the switching circuit and the smoothing capacitor are connected in series.

11. A switching power supply comprising plural transformers to which a DC voltage is applied by turning on/off of a switching circuit and which induce a voltage to be an output at secondary windings,
wherein the transformers have first primary windings connected in parallel and second primary windings connected in series, and
the first primary windings and the second primary windings are connected in series.

12. A switching power supply comprising plural transformers having first primary windings connected in parallel, second primary windings connected in series, and secondary windings to which a DC voltage is applied by turning on/off of a switching circuit and which induce a voltage to be an output,
wherein the first primary windings are connected as reset windings so that a voltage in a resetting direction is applied thereto when the switching circuit is off.
